(19) United States
(12) Patent Application Publication
(10) Pub. No.: US 2008/0145679 A1
(43) Pub. Date: Jun. 19, 2008

(54) METHOD FOR BONDING GOLD FOIL AND PRODUCT USING THE SAME

(76) Inventor: Chun Ja HAN, Seoul (KR)

Correspondence Address: IPLA P.A., 3580 WILSHIRE BLVD., 17TH FLOOR, LOS ANGELES, CA, 90010, US

(21) Appl. No.: 11/833,622

(22) Filed: Aug. 3, 2007

(30) Foreign Application Priority Data
Dec. 14, 2006 (KR) 10-2006-0127603

(51) Int. Cl. B32B 15/04; B29C 65/54

(52) U.S. Cl. 428/457; 156/278

(57) ABSTRACT

Provided is a method for bonding a gold foil. The method includes coating a lower primer adhesive layer on a surface of an object and drying the coated lower primer adhesive layer; adhering and bonding a thin gold foil onto the lower primer adhesive layer; coating an upper primer adhesive layer on the bonded gold foil and processing the coated upper primer adhesive layer by surface curing; and forming a coating layer on the upper primer adhesive layer that is coated on the gold foil.

### CROSS REFERENCE

This application claims foreign priority under Paris Convention and 35 U.S.C. §119 to Korean Patent Application No. 10-2006-0127603, filed Dec. 14, 2006 with the Korean Intellectual Property Office.

### BACKGROUND OF THE INVENTION

1. Field of the Invention

The present invention relates to a method for bonding a gold foil and a product using the same, and more particularly, to a method for bonding a gold foil, for preventing a bonded gold foil from being separated from a surface of an object as well as preventing the gold foil from being polluted and lost, and a product using the same.

2. Description of the Related Art

As well known in the art, gold has an atomic number of 79, a scientific name of Au (Aurum), a melting point of 1064.43° C., a boiling point of 2807° C., and a density of 19.32 g/cc. In particular, a pure gold is a pure material having no chemical (oxidation) reaction with other materials and having a stable structure in a proper molecular state.

Assertions are being made that in the Middle Ages, a pure gold was used for milk safekeeping, and there were not almost the killed and the injured within a palace though many people of the European continent died of the plague, because gold and silver were of much use for palace decorations and building materials and functioned as a preservative.

Even in the real antibacterial experiment (FITI test 92-00-41-01367). it was made clear that staphylococcus aureus was decreased. The reason is a complex action of a pure gold, but a fundamental cause is a high reflectance of infrared rays and an excellent thermal (optic) conductivity of the pure gold. This is because the pure gold performs endothermic and exothermic reactions for light of ultraviolet-ray series (500 nm) or less and performs selective reflection of light of infrared-rays series (550 nm) or more, thereby providing an excellent thermal conductivity and performing selective reflection of light.

FIG. 1 shows a general semi-gloss test for a pure gold bath sample.

Referring to FIG. 1, owing to an excellent thermal conductivity, a pure gold repeatedly absorbs and reflects a heat generated around and continuously generates an infrared-ray series heat in a perfect state. In other words, an antibacterial action is implemented because exothermic/endothermic reaction itself required for the propagation of bacteria is controlled owing to the selective optic (thermal) reflection/absorption and the excellent thermal conductivity of the pure gold.

A pure gold has influence on an exothermic or endothermic action of bacteria or virus. In a region in which a pain is felt, much heat is really emitted and an electrical resistance numerical value is reduced. If the pure gold contacts with this pain region, it selectively reflects energy (heat) of 550 nm or more among energy (heat) emitted from the pain region and returns the reflected energy (heat) to human body. Thus, a transmittance of the selectively reflected light (heat) is applied more deeply into skin than that of light of a different wavelength, thereby treating dermatitis.

In particular, the pure gold performs selective reflection even in a visible nature environment, but has influence on a skin tissue when it gets in contact with skin. The pure gold repeats selective reflection/absorption of a heat emitted from a human body, thereby generating a secondary heat (light). The radiated secondary heat is forwarded to skin and is applied deeply into skin unlike a heat having a wavelength range close to ultraviolet rays. An infrared-ray series light (heat) increases a skin temperature and makes a skin tissue smooth. The skin tissues made smooth are stimulated under the influence of an infrared-ray series wavelength and are brought into active action, thereby helping skin cleanup and waste elimination.

In addition, in the physical property of a pure gold, a thermal (electric) conductivity is excellent and electromagnetic transmission is easy. The pure gold has a yellow color when being of a lump type and has a green color when being of a thin plate type. The pure gold has a white color when it is with mercury. At the time of observation with general eyesight, the pure gold is seen as having a gold color (yellow color). A semi-gloss spectrum (a reflected light) is seen as having a red series color. A proper wavelength is seen as having about 190 nm to 260 nm.

Physiological reaction-related chromatic program

| Vibration | | |
|---|---|---|
| (wavelength) | Physiological reaction | Effects |
| 11 Blue color | Energy fluidity and immunity promotion | Restoration |
| 77 Sky blue | Tension relaxation and physical inconvenience settlement | Relaxation |
| 71 Indigo blue | Making over-expanded blood circulation smooth | Fluidity |
| 74 Pale blue | Muscle tension relaxation | Muscle relaxation |
| 75 Azurite blue | Blood vessel cleaning and excessive residue settlement | Drainage |
| 37 Green | Secretion control and blood circulation promotion | Cleanup |
| 35 Pastel green | Hypodermic tissue cleaning and tension relaxation | Cleanness |
| 31 Deep green | Settlement of secretion accumulated in body | Transfer |
| 33 Green ochre | Cell function control | Cleanup |
| 13 Yellow | Cell function balancing | Adjustment |
| 15 Cream | Cell function tempo control and interference elimination | Normalization |
| 23 Orange + yellow | Absorption and re-absorption function promotion | Intake |
| 54 Pink salmon | Hypodermic tissue relaxation and state improvement | Correction |
| 27 Orange | Nutritive element elimination and vigor coloring complement | Recharge |
| 25 Salmon | Hypodermic tissue elasticity increase | Correction |
| 22 Reddish orange | Intake decomposition and nutritive element reproduction | Reproduction |
| 24 Pale salmon | Elasticity increase of connection tissue | Strong elasticity |
| 12 Red | Muscle power distribution and hypodermic tissue | Rehabilitation |
| | strengthening | |
| 14 Pink | Oxidation function decrease | Settlement |
| 52 Ruby and red | Surface tissue reproduction | Wrinkle free |
| 46 Reddish violet | Blood vessel expansion and contraction control | Edema prevention |
| 44 Light purple | Excess body heat and blood circulation control heat | Control |
| 47 Violet | Color tone strengthening and muscle elasticity strengthening | Reduction |
| 16 Lilac | Muscle contraction and excess energy circulation elimination | Deliquescence |
| 41 Blue violet | Artery and vein circulation improvement | Circulation |
| 72 | Application to tendon pain | Varying |
| | | depending on |
| | | constitution |
| 21 | Application to heavy pain in motion | Fluidity |
| 32 | Overwork pain | Blood pressure |
| 57 Ochre | In-body hematuria prediction | Prediction |
| 5.5 + 5.5 | Nervous tissue stimulus | AU reproduction |
| 6.5 + 6.5 | Blood circulation stimulus | AG reproduction |

| Color | Wavelength range (Å) | Activity and effect |
|---|---|---|
| Red | 6,300 to 7,700 | Promotion of the circulation of blood, decongestion, stimuli |
| | | of the senses of smell, sight, hearing, touch, and taste, |
| | | activation of the sympathetic system |
| Orange | 5,900 to 6,550 | Affection to physical vitality, keeping the balance of body and |
| | | mind, treatment of melancholia |
| Yellow | 5,500 to 5,900 | Nerve strengthening, thought promotion, activation of motive |
| | | nerves, creating energy used for muscles (strengthening |
| | | digestive function upon irradiation into stomach system for a |
| | | short time) |
| Green | 4,900 to 5,500 | Antibacterial action, destroying cancer cells |
| Blue | 4,500 to 4,900 | Peace of mind, poison counteracting effect, effect on heat, |
| | | pulse pain, infection, inflammation (pimple, jaundice, |
| | | arthritis treatment) |
| Indigo | 4,100 to 4,500 | Making mind peaceful, making free from fear and repression, |
| blue | | used for eye disease and ear disease |
| Purple | 3,900 to 4,100 | Relieving symptom of mental disease, controlling |
| | | susceptibility, suppression of appetite, leucocyte formation, |
| | | keeping the balance of potassium/sodium ions |

In order to make a product using gold, various methods were tried that gold is melted and directly molded or a product is plated with gold. However, it was difficult to make a product due to economical efficiency and stability because gold is produced by a small amount and is expensive.

Specifically, in case where a product is produced by plating, there occurs a drawback that a plated gold is peeled off and lost because its bonding force is changed and weakened as a long time passes after a plating work is applied to an object such as a bathtub, accessories, and household goods. And, there is a drawback that as time goes by, there occurs a change of a surface color and a thermal conductivity and there occurs an abrasion phenomenon due to weatherability and natural devastation, because provision of a fine gas-bonded grain in a plating surface increases hardness but changes the original physical properties of gold such as an excellent ductility and an excellent thermal conductivity.

Plating requires a variety of equipments. Because a plating solution is prepared by mixing separate chemicals, there occur an increase of a prime cost, a limitation to processing (plating) depending on a size of product, evils of environmental pollution caused by a plating wastewater.

In order to solve such drawbacks, there is provided Korean Patent Application No. 2004-0009993 earlier filed by this applicant. This invention discloses that a thin gold foil layer 3 is adhered to a bathtub 1 up/down and left/right and a resin coating layer 5 is coated on an external surface of the gold foil layer 3 as shown in FIG. 2.

However, in case where the gold foil layer 3 is adhered onto the bathtub 1 and the coating layer 5 is coated straightly on the gold foil layer 3 as above, a primary coupling between the gold foil layer 3 and the coating layer 5 is provided but a perfect inter-metal coupling of the gold foil layer 3 is not provided unlike a board or an object having a constant thickness, when the gold foil layer 3 is coated at a small thickness of about 1 μm. Thus, there is a drawback that a gold foil itself is separated in a thin plate form and thus, part of the gold foil remains adhered to the coating layer 5 and the remainder remains on a lower adhesive layer.

This can provide superior adherence using a heterogeneous adhesive between an upper coating layer and the lower adhesive layer, but has a drawback that a gold foil, a middle thin plate, is separated. Also, a direct coupling between the gold foil layer 3 and the coating layer 5 causes a problem even in adherence because the properties of a coating agent, that is, a smoothness and hardness for surface protection are increasingly applied.

The gold foil layer 3 having an excellent thermal conductivity and being sensitive to a change of temperature is frequently contracted and expanded due to a direct change of exterior temperature. This phenomenon results in formation of a small space between the gold foil layer 3 and the coating layer 5 and causes the adhered gold foil layer 3 to be peeled off. In addition, the gold foil layer 3 is vulnerable in its heat conservation because a sudden change of external temperature is forwarded to the gold foil layer 3 as it stands, and a heat reflected from the gold foil layer 3 passes through the coating layer 5 as it stands.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to provide a method for bonding a gold foil, for enabling bonding to an object as maintaining the original property of gold, minimizing a heterogeneity sensation and improving a thermal conductivity even in heterogeneous bonding, and preventing gold from changing in color or being peeled off and lost even when a long time after bonding lapses.

According to one aspect of the present invention, there is provided a method for bonding a gold foil. The method includes coating a lower primer adhesive layer on a surface of an object and drying the coated lower primer adhesive layer; adhering and bonding a thin gold foil onto the lower primer adhesive layer; coating an upper primer adhesive layer on the bonded gold foil and processing the coated upper primer adhesive layer by surface curing; and forming a coating layer on the upper primer adhesive layer that is coated on the gold foil.

The lower primer adhesive layer and the upper primer adhesive layer may use the same-series adhesive agent.

The lower primer adhesive layer may be dried for 15 to 30 minutes after coated. The upper primer adhesive layer may be processed for three hours by surface curing.

### BRIEF DESCRIPTION OF THE DRAWINGS

The accompanying drawings, which are included to aid in the above and other objects, features and advantages of the present invention will become more apparent from the following detailed description when taken in conjunction with the accompanying drawings in which:

FIG. 1 shows a general semi-gloss test for a pure gold bath sample;

FIG. 2 is an exploded cross section illustrating an example of a conventional state where a gold foil is bonded; and

FIG. 3 is an exploded cross section illustrating an example of a state where a gold foil is bonded according to the present invention.

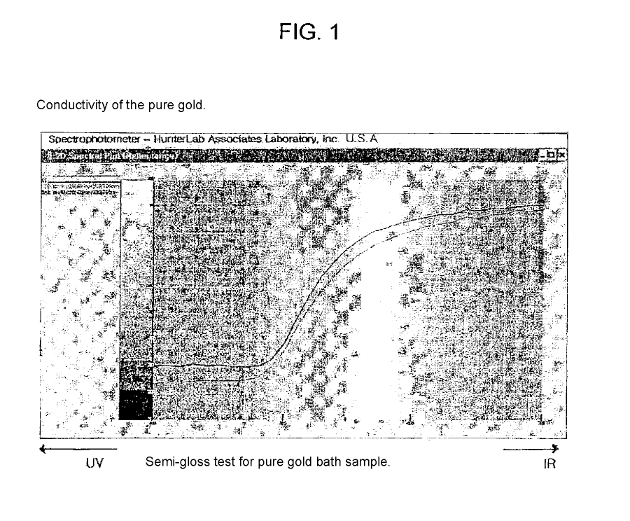

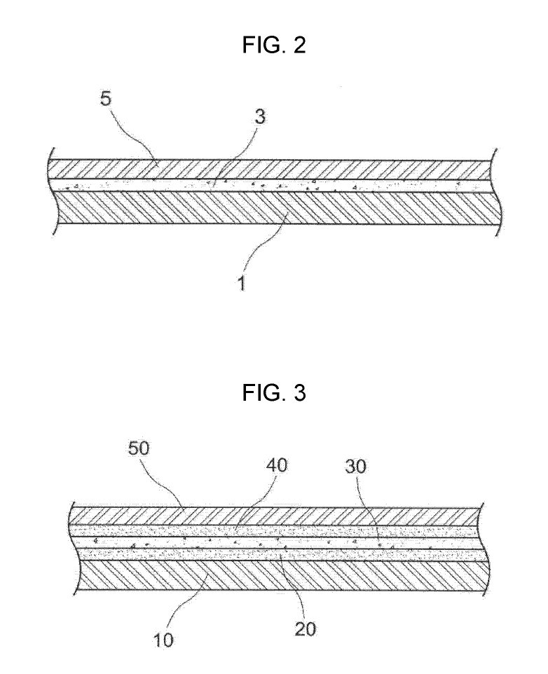

Throughout the drawings, the same drawing reference numerals will be understood to refer to the same elements, features and structures.

### DETAILED DESCRIPTION OF THE INVENTION

Exemplary embodiments of the present invention will now be described in detail with reference to the annexed drawings. In the following description, a detailed description of known functions and configurations incorporated herein has been omitted for conciseness.

In the present invention, a thin gold foil having a small thickness is bonded to a surface of an object 10 such as household goods. For this, as shown in FIG. 3, a lower primer adhesive layer 20 is coated on the surface of the object 10 and then is dried to some extent for about 15 to 30 minutes. By doing so, the gold foil is bonded on the lower primer adhesive layer 20, thereby forming a gold foil layer 30.

Unlike a conventional art in which a coating layer is formed directly on the gold foil layer 30, the present invention thinly coats the same upper primer adhesive layer 40 as the lower primer adhesive layer 20 on the gold foil layer 30, processes the coated upper primer adhesive layer 40 by surface-curing for about three hours, and coats a fluorine-based coating layer 50 on the surface-cured upper primer adhesive layer 40.

In other words, in the conventional art, a coating layer 5 was formed directly on a gold foil layer 3 under the recognition that the coating layer 5 protects the gold foil layer 3. It is a new technology having never been attempted before to separately form the upper primer adhesive layer 40 between the gold foil layer 30 and the coating layer 50 as in the present invention.

However, in a conventional art in which the lower primer adhesive layer 20 is formed only on a lower part of the gold foil layer 30, there is a drawback that the gold foil layer 30 is merely firmly bonded only to the lower primer adhesive layer 20 and as a long time goes by, a small gap is generated between the gold foil layer 30 and the coating layer 50 and the gold foil layer 30 is seen differently from its own color or is lost and disappeared. In the present invention, the same-series adhesive layers 20 and 40 are coated on an upper part and a lower part of the gold foil layer 30, respectively. Thus, the lower and upper primer adhesive layers 20 and 40 not only cover and protect the upper and lower parts of the gold foil layer 30 but also even when the gold foil layer 30 having an excellent conductivity is repeatedly contracted and expanded, they perform a shock-absorbing function like a sponge, thereby preventing spacing-away and separation between the coating layer 50 and the gold foil layer 30.

The lower primer adhesive layer 20 and the upper primer adhesive layer 40 use the same-series primer adhesive agent. Thus, the same primer adhesive agent is filled even in a small gap caused by the separation of the gold foil layer 30. Thus, the continuity of homogeneity sensation and the miniaturization of heterogeneity sensation can lead to achievement of stability as well as prevention of a peel-off phenomenon of the gold foil layer 30 or the coating layer 50 and the improvement of a protection of a product surface. Of course, diverse application and use depending on a target object can be implemented such that when the upper and lower primer adhesive layers 20 and 40 use an acrylic-based adhesive agent, the coating layer 50 uses a fluorine-based coating agent, and when the upper and lower primer adhesive layers 20 and 40 use a fluorine-based adhesive agent, the coating layer 50 use an Unsaturated Polyester (UP)-based coating agent.

Because the upper primer adhesive layer 40 and the coating layer 50 provided on the gold foil layer 30 have a different refractive index of light and heat, they sequentially transfer a heat despite a sudden change of an external temperature, thereby preventing a sudden change of a gold foil. The transferred heat is repeatedly reflected and conducted in the adhesive layers 20 and 40 and the coating layer 50, thereby preventing a sudden diffusion and being of a help to temperature maintenance.

According to the present invention, a gold foil product is manufactured using the method for bonding the gold foil. According to the method, a lower primer adhesive layer 20 is coated and dried on a surface of an object 1 0. Next, a thin gold foil 30 is adhered and bonded onto the lower primer adhesive layer 20. After that, an upper primer adhesive layer 40 is coated on the bonded gold foil 30 and the coated upper primer adhesive layer 40 is processed by surface curing. Next, a coating layer 50 is formed on the upper primer adhesive layer 40 that is coated on the gold foil 30.

The lower primer adhesive layer 20 and the upper primer adhesive layer 40 use the same-series adhesive agent.

The lower primer adhesive layer 20 is dried for 15 to 30 minutes after coated.

The upper primer adhesive layer 40 is processed for three hours by surface curing.

As described above, the present invention is very useful in using the properties of gold beneficial to a human body while maintaining the basic physical properties of gold that is an expensive material as it stands, reducing a cost by the use of a thin foil type gold, providing a solution to a problem of a gold foil work that the utilization of gold is limited by peeling-off, loss, and conservativeness, and reducing economic and environmental evil by the simplification of a process equipment.

Also, the present invention has an advantage that a change of a simple construction is given, thereby preventing a gold foil from being lost or deformed, and heterogeneous adhesive agent and coating agent are coated on the gold foil, thereby preventing a change of an exterior temperature from causing a sudden conduction or diffusion of an exterior heat to the gold foil and thus, promoting a long life of the gold foil.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for bonding a gold foil, the method comprising:
coating a lower primer adhesive layer on a surface of an object and drying the coated lower primer adhesive layer;
adhering and bonding a thin gold foil onto the lower primer adhesive layer;
coating an upper primer adhesive layer on the bonded gold foil and processing the coated upper primer adhesive layer by surface curing; and
forming a coating layer on the upper primer adhesive layer that is coated on the gold foil.

2. The method of claim 1, wherein the lower primer adhesive layer and the upper primer adhesive layer use the same-series adhesive agent.

3. The method of claim 1, wherein the lower primer adhesive layer is dried for 15 to 30 minutes after coated.

4. The method of claim 1, wherein the upper primer adhesive layer is processed for three hours by surface curing.

5. A gold foil product comprising a method for bonding a gold foil, the method comprising:
coating a lower primer adhesive layer on a surface of an object and drying the coated lower primer adhesive layer;
adhering and bonding a thin gold foil onto the lower primer adhesive layer;
coating an upper primer adhesive layer on the bonded gold foil and processing the coated upper primer adhesive layer by surface curing; and
forming a coating layer on the upper primer adhesive layer that is coated on the gold foil.

6. The product of claim 5, wherein the lower primer adhesive layer and the upper primer adhesive layer use the same-series adhesive agent.

7. The product of claim 5, wherein the lower primer adhesive layer is dried for 15 to 30 minutes after coated.

8. The product of claim 5, wherein the upper primer adhesive layer is processed for three hours by surface curing.
